(19) United States
(12) Patent Application Publication
(10) Pub. No.: US 2025/0177964 A1
(43) Pub. Date: Jun. 5, 2025

(54) SYNTHESIS PROCEDURE OF HOMOPOLYMERS AND COPOLYMERS BASED ON VINYL IONIC LIQUIDS, N-VINYLPYRROLIDONE OR VINYLPYRIDINE AND THE METHODOLOGY FOR THEIR APPLICATION AS CATALYSTS IN ALKYLATION REACTIONS OF ISOPARAFFINS AND OLEFINS

(71) Applicant: Instituto Mexicano del Petróleo, Mexico City (MX)

(72) Inventors: Araceli Vega Paz, Mexico City (MX); Mercedes Bazaldua Domínguez, Mexico City (MX); Diego Javier Guzmán Lucero, Mexico City (MX); José Gonzalo Hernández Cortez, Mexico City (MX); Nohemí Ornelas Robles, Mexico City (MX); Javier Guzmán Pantoja, Mexico City (MX); Rafael Martínez Palou, Mexico City (MX)

(21) Appl. No.: 18/965,000

(22) Filed: Dec. 2, 2024

(30) Foreign Application Priority Data
Nov. 30, 2023 (MX) MX/A/2023/014322

(51) Int. Cl. B01J 31/10; B01J 37/04; B01J 37/30; C08F 8/44; C10L 1/04

(52) U.S. Cl. CPC B01J 31/10; B01J 37/04; B01J 37/30; C08F 8/44; C10L 1/04; C10L 2270/023

(57) ABSTRACT

The present disclosure relates to a procedure for the synthesis of polymers (homo and copolymers) of the poly (ionic liquid) (PIL) type. The homopolymers are derived from polyvinylimidazolium, polyvinylpyrrolidone or polyvinylpyridine and the copolymers from monomers of vinyl ionic liquids (ILs) are derived from imidazole and N-vinylpyrrolidone. The structural modification of these homopolymers and copolymers occurs by using strong inorganic acids such as sulfuric, chlorosulfonic and bromosulfonic, among others, and halide metallic salts such as AlCl₃, FeCl₃, CuCl, ZnCl₂, and SnCl₂. Also, these PILs are employed as catalysts in alkylation reactions between isoparaffins and olefins for producing alkylate gasoline.

### CROSS-REFERENCE TO RELATED APPLICATIONS

This patent application claims priority under 35 U.S.C. Section 119 to Mexican Patent Application No. MX/a/2023/014322, filed Nov. 30, 2023, the entire disclosure of which is incorporated herein by reference.

### FIELD

The present disclosure relates to a procedure for the synthesis of poly(ionic liquid) polymers to be employed as catalysts in alkylation reactions between isoparaffins and olefins for the production of alkylate gasoline.

### BACKGROUND

Poly(ionic liquid)s (PILs) are polyelectrolytes that have repeating units consisting of ionic liquids (ILs) derived from vinyl or bifunctional monomers that can be polymerized either by polyaddition or polycondensation, respectively. Polyelectrolytes are known as cationic or anionic when the positive or negative charge is located at the repeating unit of the main polymer chain. This fact is reflected by unique properties in terms of processability, stability, durability and recyclability. The distribution of positive or negative charges or both, in addition to include different chemical functionalities, provides many possibilities for modulating properties such as rheological, physicochemical, magnetic, etc., and acidity among them [Chem. Soc. Rev. 2017, 46, 1124-1159]. Unlike many non-polymeric ILs, PILs are compounds in condensed state at ambient temperature and then, they can have morphologies that cannot be achieved by employing non-polymeric ILs such as the formation of hypercrosslinked structures, porous polymeric films, expanding polymers and macromolecular architectures in flexible solid films [Polymers 2011, 52, 1469-1482]. These features widen the application horizon of PILs in different science and technology fields, where their use as catalysts of heterogeneous phase reactions is among them [Eur. Polym. J. 2017, 90, 245-272].

Some of the main advantages of PILs with respect to catalysts based on inorganic acids, which are the most commonly used in the industry, are their low toxicity, negligible volatility and low corrosivity. On the other hand, PILs are more advantageous than non-polymeric ILs, because macromolecules featuring different Lewis and/or Brønsted acid sites in their chemical structure can be designed. This fact gives the possibility of designing catalysts with the acidity and stability necessary for the optimal performance in the reactions they take part [Chem. Rev. 2016, 116, 6133-6183]. In addition, PILs with higher reactant contact surface can be obtained in such a way that the Brønsted and Lewis acidity can be modulated in order to enhance the catalytic performance and chemical stability in the presence of humidity. The heterogeneous solid-liquid reaction systems allow the easy separation of the catalyst from the reaction products.

Polymers and copolymers derived from PILs with porous structures have sites that favor the improved interaction of the reactants, especially when they have some swelling degree [ACS Macro Lett. 2016, 5, 435-438] or are porous [J. Chem. Mater. 2015, 27, 127-132]. They can also be processed as IL supported membranes, films or macroporous polymeric systems by employing inorganic templates during the synthesis process [Adv. Funct. Mater. 2010, 20, 2063-2070].

In the oil industry, alkylation is the chemical process through which light and branched paraffins, like isobutane, react with light olefins such as n-butenes for obtaining branched hydrocarbons with 8 carbon atoms. During this process, different paraffins are produced, but the most interesting ones are the trimethylpentane (TMP) isomers. Also, undesired compounds with higher molecular weight like c9 + hydrocarbons occur.

In the conventional alkylation process, the industry employs catalysts such as sulfuric acid (H₂SO₄) or hydrofluoric acid (HF) to obtain alkylate gasoline. The main inconvenient points of using HF are its manipulation, leaks and formation of aerosols with lethal concentrations [J. Mol. Liq. 2019, 276, 779-793]. Due to the foregoing, currently, H₂SO₄ is more frequently used, for it is stable and presents good catalytic yield. A big drawback represented by these inorganic acids during alkylation is that high consumption is required and can be regenerated 2 or 3 times by using high water volumes, which makes it a very expensive process [Energy Fuels 2021, 35, 1664-1676]. Furthermore, H₂SO₄ is toxic, provokes burns and is highly corrosive in the presence of water.

There are many research works focused on the search of environmentally friendly catalysts with low toxicity such as heteropolyacids (HPAs) [Catal. Sci. Technol. 2017, 7, 5810-5819], silicon and Nafion nanocomposites [Energy Fuels 2006, 20, 481-487] and zeolites [Chem. Soc. Rev. 2014, 43, 7548-7561], which can be very efficient and selective, but feature fast deactivation problems, mainly because of the formation of coke that blocks active sites [Catal. Sci. Technol. 2017, 7, 5810-5819].

ILs derived from organometallic compounds represent a promising alternative to conventional acids, for their Lewis and Brønsted acidity can be adapted to the reaction requirements, they are slightly toxic and can be used for several reaction cycles before going through catalytic deactivation [Mol Catal. 2021, 515, 111892]. The ILs that are used in alkylation reactions can be classified as follows: (1) metal-based Lewis acid ILs (mainly chloroaluminates), (2) Brønsted-Lewis acid (bifunctional) ILs, (3) non-metal-based Brønsted acid ILs and (4) immobilized/supported ILs. IL chloroaluminates dissolve strong inorganic acids such as HCl and H₂SO₄ and generate superacids and due to the release of protons, this system has low solvation of the ionized species; this behavior pattern allows highly reactive catalysts with results that are comparable to those obtained with concentrated H₂SO₄ [Energy Fuels 2020, 34, 15525-15556]. The disadvantage shown by chloroaluminate-derived IL catalysts is that they deactivate irreversibly because of their humidity sensitivity, releasing HCl. For this reason, although there are industrial technologies based on this class of catalysts, research works and development of new technologies are focused on obtaining IL-based catalysts to carry out the alkylation reaction. These materials have to be chemically stable, environmentally friendly and as-many-times-as-possible reusable [Fuel 2021, 302, 121195].

Recently, the use of some PILs as effective and recyclable catalysts in the alkylation reaction was reported. For example, Yu et al., 2017, published a research work on the employment of polyethers with Brønsted acid sites under mild reaction conditions (at 60° C. for 30 min), reaching 80% of C8 selectivity from which 95% corresponded to TMPs [Catalysis Today 2017, 310, 141-145]. In 2020, Xu et al. used polyetheramine-derived PILs, where the terminal amino groups were functionalized with sulfonic groups. These catalysts were efficient in the isobutene/butene alkylation reaction, achieving 86.6% of C8 compound selectivity. The reaction was carried out at ambient temperature for 25 min [China Petrol. Petrochem. Technol. 2020, 22, 64-70].

Polymers belonging to the polyvinylpyridine poly(VPy) family are very versatile, particularly 4-polyvinylpyridine poly(4VPy), and suitable for numerous applications. For example, these compounds are widely used to produce antibacterial surfaces or systems that are sensitive to pH or that respond to local environment changes with unique transitions from the hydrophobic to hydrophilic state or systems with tridimensional order at molecular level. Furthermore, the quaternized or protonated forms of poly(VPY) can interact electrostatically with charged surfaces, whereas the pyridinium groups can interact with diverse non-metallic polar surfaces, specially ending in amino, carboxyl, hydroxyl or other groups capable of creating hydrogen bonds [C. S. Hsu and P. R. Robinson, “Gasoline production and blending,” in Springer Handbooks, vol. 1, Springer, 2017, p. 551. doi: 10.1007/978-3-319-49347-3_17].

Poly(N-vinylpyrrolidone) (PVP) is an important and attractive polymer from the industrial point of view. It is used in the cosmetic, pharmaceutical and biomedical sectors, because it is biocompatible, hemocompatible and slightly toxic; it is also used as a versatile excipient in conventional formulations and in the novel controlled drug release systems [Awasthi R, Manchanda S, Das P, Velu V, Malipeddi H, Pabreja K, Pinto T, Gupta G, Dua K. In: Parambath A (ed) Engineering of Biomaterials for Drug Delivery Systems. Chap. 9 Poly(vinylpyrrolidone), Woodhead Publishing, 2018]. It is also used in the paper, fiber, textile, coating, and ceramic industries, among others, mainly because it exhibits outstanding physichochemical properties; it specially features high thermal resistance [AAPS PharmSciTech 2021, 22, 1-16]. It is a polymer that is non-ionic, amorphous and soluble not just in water, but in various organic solvents, and it does not feature the lower critical solution temperature behavior pattern [J. Polym. Res. 2011, 18, 2307-2324]. Although it has not been confirmed that PVP is biodegradable, the fact that PVP is potentially biodegradable when specific microorganisms are employed is a very interesting subject matter that is still being investigated [Robinson, B. V., Sullivan, F. M., Borzelleca, J. F., & Schwartz, S. L. PVP: a critical review of the kinetics and toxicology of polyvinylpyrrolidone (povidone). CRC Press, 2018].

PVP has been used as surfactant in Fe (III)-based organometallic catalytic systems, according to the description of US Patent Application Publication No. US 2016/027961.6 A1, for the production of biodiesel. The same surfactant effect has been displayed in oxidation reactions for the synthesis of vinyl acetate from ethylene and acetic acid according to the U.S. Pat. No. 6,603,038 B1.

PVP-based polymers result functional in hydrogenation reactions by including different metal salts in their structure; for example, in the document U.S. Pat. No. 4,783,284, PVP with molecular weight between 100,000 and 300,000 g/mol, in combination with metals such as platinum, rhodium, ruthenium and osmium, works as a catalyst in the hydrogenation reaction of alkylanthraquinone, where it is remarked that the required organic catalyst amount ranged from 0.5 to 10 wt. % for hydrogenation, achieving conversions between 64 and 100% when one alcohol type was used as solvent.

The development of PVP-based copolymers (with 2 or more different repeating units) has diverse applications such as in electrolytic membrane fuel cells, where N-vinylpyrrolidone (NVP) can be copolymerized with IL-derived vinyl monomers in order to achieve the efficient transport of protons [ChemSusChem 2002, e202200071]; in the oil industry, where it is used in the form of copolymers or terpolymers for enhanced oil recovery; in the last two applications, the NVP repeating unit is located either in the copolymers or terpolymers along with the acrylic monomeric units of the IL 2-acrylamido-2-methylpropane sulfonic acid (AMPS) or its sodium salt [Chem. Eng. Tech. 2022, 45, 998-1016].

The importance of developing copolymers lies in the incorporation of different monomers in order to provide diverse physical and/or chemical properties in the same macromolecule, which promote the formation of polymeric materials that combine not only the individual properties of the monomeric units, but also display macrostructural synergy to produce high performance materials. The properties of interest are correlated with the copolymer structure like the molecular weight distribution and composition of the monomer sequence, which are of great importance for the design and readiness of the materials that are conceived for specific applications.

Many patents related to the use of acid ILs as catalysts of the alkylation reaction between isobutane and butenes have been published [U.S. Pat. Nos. 7,432,409 B2, 6,797,853 B2, ES 2,742,380, U.S. Pat. Nos. 9,096,487 B2, 7,285,698 B2, 7,732,363 B2, 9,914,674 B2, 8,729,329 B2], but as far as it is known, there are no patents for the same catalytic application, where acid PILs or copolymers derived from vinyl ILs, N-vinylpyrrolidone or pyridinium groups are used.

### SUMMARY

As a consequence of the deficiencies in the art, the present disclosure intends to provide a process that is simple, economically viable and highly selective for the introduction of alkylate gasoline. The present disclosure also relates to supply catalysts that can be reused in various reaction cycles, that can achieve high conversion of olefins, high selectivity to isoparaffins, mainly TMPs, under mild reaction conditions, and that are characterized by being catalysts that can be easily separated from the reaction mixture.

The previous technologies known by the applicant were surpassed by the present disclosure, because it provides novel ionic polymeric catalysts that work in heterogeneous phase to perform the reaction that produces alkylate gasoline through the Friedel-Crafts alkylation reaction between isoparaffins and olefins.

The synthesis of ionic polymeric chemical structures that work as catalysts of the alkylation reaction between isoparaffins and olefins, achieving minimal olefin conversions of 50% and minimal isoparaffin selectivity of 30%, mainly TMPs, is one characteristic of the present disclosure.

Another characteristic of the present disclosure is that these ionic polymeric catalysts can be recycled for at least three cycles without the conversion and selectivity being affected as far as 10% of their initial values.

Additionally, the operation conditions, optimized in the present disclosure, are mild (temperatures as high as 100° C. and pressure values as high as 2 MPa).

Still, an additional characteristic of the present disclosure is that the ratio between hydrocarbons (isoparaffins and olefins) and catalyst is above 7.6.

The previous and other items in the present disclosure will be established more clearly and in detail in the following chapters.

According to the presented information, and to the best of the authors' knowledge of the present disclosure, there are no records describing the use of PILs for the isobutene/butene alkylation reaction. The novelty lies in the fact that by using a solid catalyst (having both acid functionalities, Lewis and Brønsted) better handling control of the catalyst is achieved, avoiding losses and facilitating the separation of the product and subproduct currents. Furthermore, the operation costs are reduced.

The alkylation processes implemented at industrial level use either hydrofluoric acid or sulfuric acid, i.e. liquid substances. Furthermore, there are other proposals reported in patents and specialized literature on the use of ILs or ILs supported on inorganic materials. Based on the foregoing, the present disclosure here presented surpasses what has been reported on the state of the technique due to the particularity of PILs remaining in solid state under the operation conditions of the isobutene/butene alkylation reaction.

The synthesis process of PILs from their monomers is not a trivial process. The process here claimed in the present disclosure includes 5 stages with various sequences that have to be followed to obtain a functional structure having the necessary acid strength to carry out the alkylation reaction, but at the same time, being capable of preventing the polymerization of the hydrocarbon structure in order to produce the TMP compound family as a priority. For this reason, it is neither obvious nor immediate the deduction of the present disclosure here presented from information available in the literature.

### BRIEF DESCRIPTION OF THE DRAWINGS

FIG. 1. ¹H NMR of the homopolymer P(BVim[Br]).

FIG. 2. Thermogram of sulfonated polyvinylpyrrolidone for establishing the humidity percentage and sulfonation degree.

FIG. 3. SEM of the catalyst PVPHSO₄[Cl]—AlCl₃.

FIG. 4. Brønsted and Lewis acidity of the catalysts PVPHSO4 and PVPHSO₄[Cl]—ZnCl₂.

FIG. 5. SEM-EDAX of the catalyst PVPHSO4[Cl]-FeCl₃.

FIG. 6. ¹H NMR of the copolymer P(VP-EtVim[Br]) (70-30).

FIG. 7A. Chemical structure of the polymer poly(4VPyPS).

FIG. 7B. ¹H NMR spectrum of poly(4VPyPS).

FIG. 8. SEM-EDAX of the catalyst poly(4VPyPS)-AlCl₃.

### DETAILED DESCRIPTION

The present disclosure deals with a synthesis process of PIL polymers and their application as catalysts of the reactions between isoparaffins and olefins for producing alkylate gasoline. Such PILs include polyvinylimidazolium, polyvinylpyrrolidone, polyvinylpyridine and the copolymers between the vinyl IL monomers derived from imidazole, N-vinylpyrrolidone and vinylpyridine. The present disclosure comprises the structural modification of these homopolymers and copolymers with strong inorganic acids such as sulfuric, chlorosulfonic, bromosulfonic, and alkyl sulfonic acids, among others, and halide metallic salts such as AlCl₃, FeCl₃, CuCl, ZnCl₂, and SnCl₂, but not exclusively.

The methodology of the present disclosure includes of 5 stages, which are described as follows:

First stage: This stage refers to the synthesis of ionic polymeric compounds based on repeating units derived from vinylpyridine, N-vinylpyrrolidone and/or vinyl ionic liquids, which in combination with metallic halide salts such as AlCl₃, FeCl₃, CuCl, ZnCl₂, and SnCl₂, but not exclusively, promote the alkylation reaction between isoparaffins and olefins for producing alkylate gasoline.

Second stage: This stage refers to a procedure for synthesizing ionic homopolymers and copolymers that are synthesized from unsaturated monomers that have a vinyl group bound to the pyrrolidone, imidazole or pyridine group. These monomers can be homopolymerized or copolymerized through the free-radical mechanism, employing polymerization initiators, which can include, but not be limited to: initiators with peroxide such as benzoyl peroxide, cumene peroxide, 2-tert-butylperoxybenzoate, acetyl peroxide, etc. Initiators with azo compounds such as azobisisobutyronitrile (AlBN), 2,2′-diamino-2-2′-azodipropane dihydrochloride, ammonium persulfate, potassium persulfate and dimethylaminopyridine, among others. Among the polymerization techniques that can be used are mass polymerization, solution polymerization, emulsion polymerization, etc. The polymerization technique employed in the present disclosure was the aqueous dispersion polymerization without this fact being a limitation to employ other polymerization techniques of vinyl monomers. Aqueous dispersion homopolymerization was carried out using vinyl ILs derived from imidazole or pyridine, which contain alkyl or alkylcarboxylic chains from 2 to 4 carbon atoms at position 3 of the imidazole ring as shown in the reaction described in Reaction 1. The copolymers based on N-vinylpyrrolidone (NVP) and ILs with alkylcarboxylic chains from 2 to 6 carbon atoms at position 3 of the imidazole ring are shown in the reactions featured in Reaction 2. The ratio of the monomers n and m in the copolymer chain can be adapted from NVP:IL molar ratios from 30:70 to 80:20 according to the physicochemical characteristics required in the alkylation reaction.

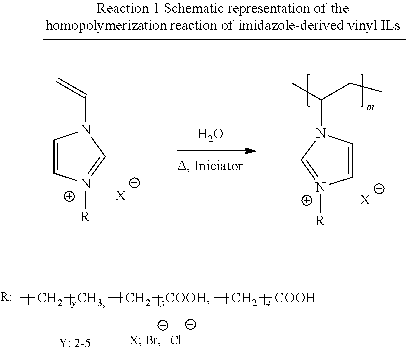

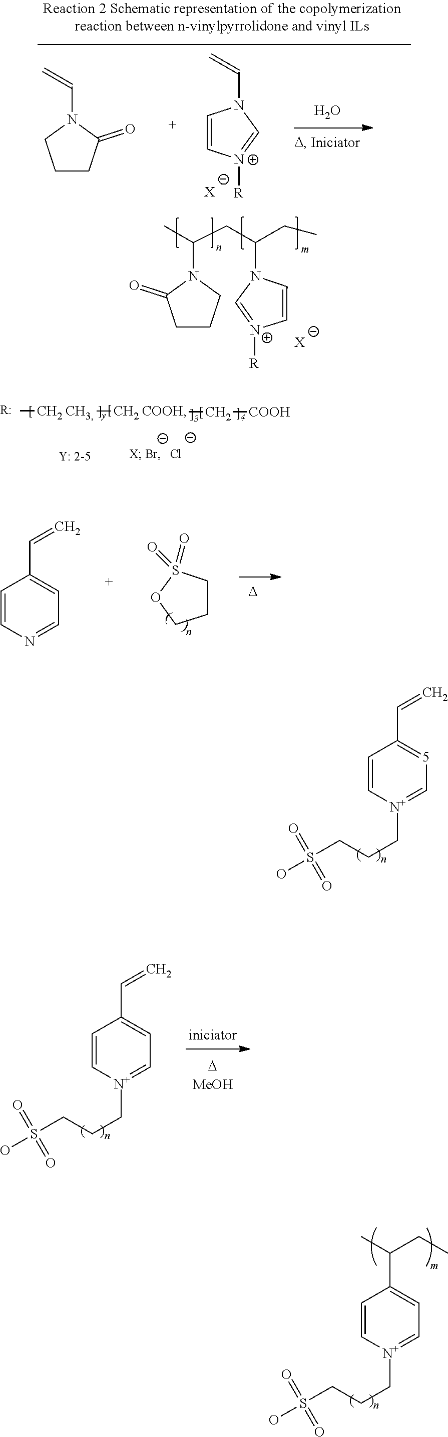

Third stage: At this stage, the modification of the chemical structure of the repeating units NVP and VPy is carried out for producing Brønsted acid sites through the introduction of the sulfonic group (—SO₃H) and of a cationic polyelectrolyte with halide counterion that can be Cl⁻ or Br⁻ by using acids such as chlorosulfonic acid, as shown in Reaction 3; also, 2-bromoetanesulfonic acid and other acids like haloalkylsulfonic and haloalkylcarboxylic or the salts of the corresponding carboxylic acids. Also, propanesultone or butanesultone can be used as sulfonating agent. Likewise, the commercially available PVP can also be employed for this reaction.

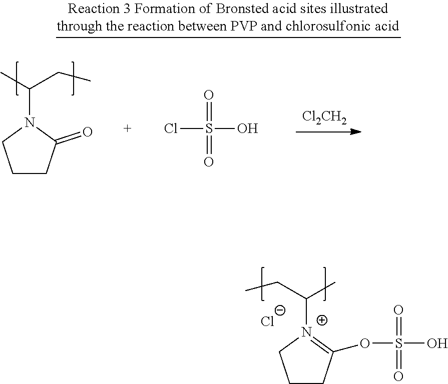

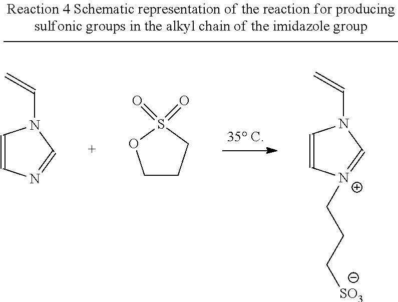

The acid groups can also be incorporated into the anion by neutralizing the zwitterionic system, obtained by incorporating the chemical structure of the sulfonic group, which is featured in the schematic representation of Reaction 4.

Fourth stage: This stage involves in generating Lewis acid sites in the structure of homopolymers and copolymers through the metathesis reaction of the halide that is found in the main chain of the homopolymers or copolymers with transition metal salts. The molar fraction of the metallic salt that is added to the polymer or copolymer ranges from X=0.50 to 0.90 and is calculated by means of Equation 1, Mol Salt corresponds to the molar concentration of the integrated metallic salt,

$$x = \frac{Mol Sal}{Mol Sal + Mol PLI} \qquad Equation 1$$

and Mol PIL corresponds to the polymer molar concentration integrated for synthesizing the catalyst.

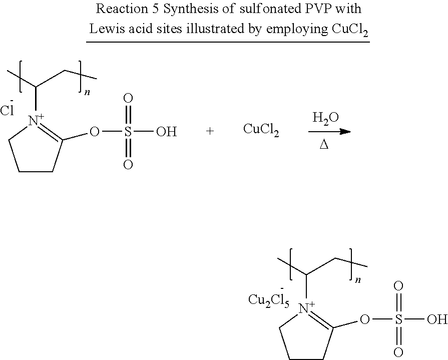

The metathesis reaction between the metallic salt and polymer or copolymer is achieved, although not exclusively, by heating at 110-140° C. in inert atmosphere by using gases such as nitrogen or argon or in vacuum. To the polymer that is under stirring, the metallic salt is added using a time interval between 0.5 h and 3 h, which is represented in Reaction 5.

Fifth stage: At this stage, the application of homopolymers or copolymers derived from VPy, NVP and vinyl IL monomers, which have metallic salts integrated into their structure, as catalysts to promote the alkylation reaction between isoparaffins and olefins for producing alkylate gasoline takes place. The reaction that is catalyzed with polymers that have the metallic salt integrated into their structure occurs in an autoclave at temperatures ranging from −20 to 100° C., at pressure values that can reach between 110 and 500 psi in inert atmosphere and at stirring rates between 500 and 1800 rpm. The polymeric catalysts that feature the integrated metallic salt (CAT) have a reaction hydrocarbon ratio (isoparaffins and olefins) HC, HC:CAT from 7.6:1 to 100:1.

### EXAMPLES

Having described the present disclosure and its characteristics, the following examples are presented with illustrative purposes and not for limiting the scope of the present disclosure.

### Example 1

### Preparation of the Homopolymer Poly (1-vinyl-3-butylimidazolium) Bromide, P(BVim[Br])

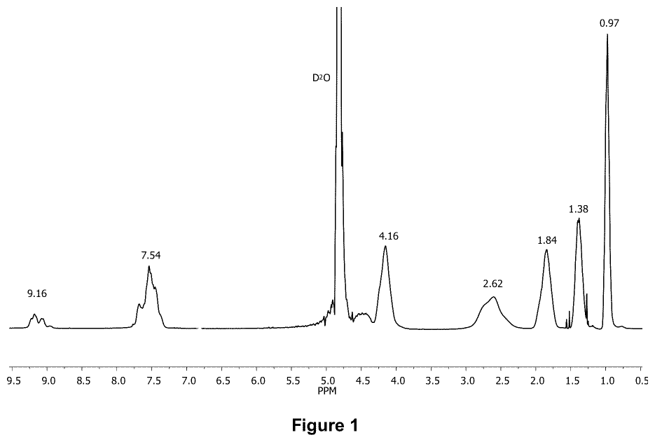

To a 100-mL-3-neck flask, 10 g of N-ethyl-N-vinylimidazolium bromide (0.043 mol) and 28 mL of deionized water were added. Air is extracted from this solution by vacuum for 20 min. Ambient pressure is restored by circulating gaseous nitrogen into the solution, which is placed in an oil bath that is previously heated to 50° C. The flask is equipped with a thermometer, refrigerant and magnetic stirrer. Nitrogen flux between 1 and 5 mL/h is set for the time at which the reaction takes place. Once the temperature of the reaction solution reaches 50° C., the initiator is added, in this case, the initiator V50, which is dissolved in 5 ml of water and introduced into the 3-neck-flask by means of a syringe pump for 30 min (0.16 mL/min). The initiator is prepared at a concentration of 0.007 mol of initiator per monomer moles (0.082 g). The polymerization reaction occurs at 50° C. and atmospheric pressure for 10 h. The polymeric product is dissolved in water and precipitates in acetone. The remaining monomer is removed by dissolving it in water and precipitating it in acetone. The polymer is dried in vacuum at 60° C. for 4 h. The dry polymer is ground and stored in a sealed container. The polymer molecular weight is 62520 g/gmol. FIG. 1 shows the NMR spectrum for polymer protons, which confirms its chemical structure.

### Example 2

### Preparation of the Poly (1-vinyl-3-ethylimidazolium) Bromide Catalyst, P(BVim[Br])—AlCl₃

In a 50-mL-2-neck-round-bottom flask, 2 g (0.006) of polymer from Example 1, a magnetic stirrer and 3.49 g (0.018 mol) of aluminum chloride were added. Aluminum chloride has a molar ratio of X=0.75 with respect to the ionic homopolymer. The flask was heated in a thermal bath up to 120° C. under constant nitrogen flow for 90 min. Once the organic material and inorganic salt are integrated, a uniform material is obtained, which is placed in a hermetically closed container and protected in nitrogen atmosphere. This material will be used as a catalyst of the alkylation reactions between isoparaffins and olefins. The molar ratio X was calculated with Equation 1.

### Example 3

### Preparation of the Sulfonated Polyvinylpyrrolidone Catalyst, PVPHSO₄[Cl]—AlCl₃

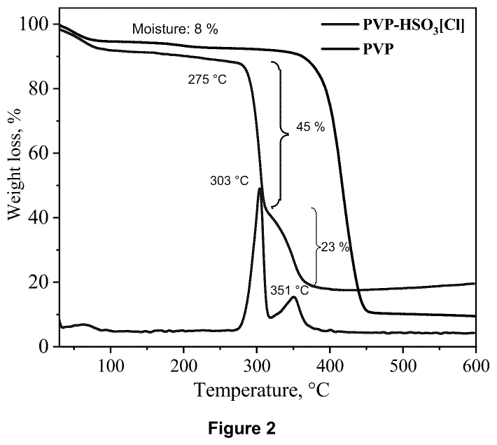

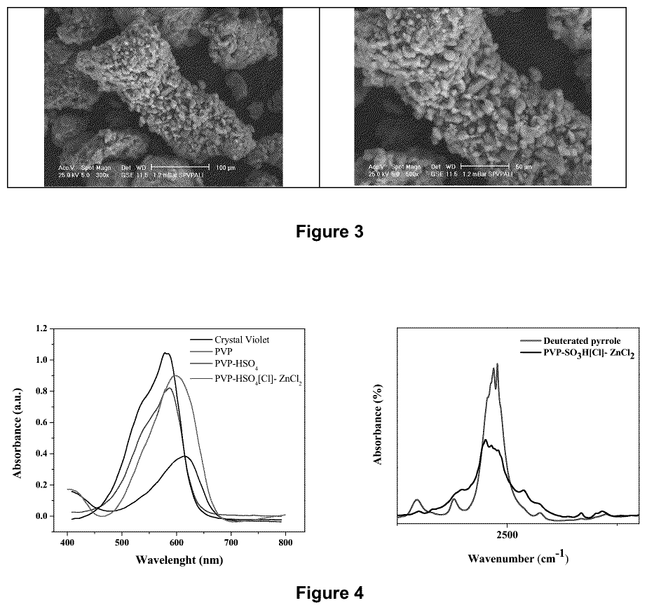

Once humidity and sulfonation degree reached by polyvinylpyrrolidone are known, for this example, a batch containing 18% of humidity and 85% of sulfonation degree was used. These two parameters can be established by thermogravimetric analysis, like the one shown in FIG. 2. In a 50-mL-2-neck-round-bottom flask, 2 g (0.006 mol) of the polymer PVPHSO₄[Cl], a magnetic stirrer and 2.47 g (0.019 mol) of aluminum chloride were added. Aluminum chloride has a molar ratio of X=0.75 with respect to PVPHSO₄[Cl] (see Equation 1). The flask was heated in a thermal bath up to 120° C. under constant nitrogen flow for 90 min. After the organic material and inorganic salt are integrated, a uniform material is obtained, which is placed in a hermetically sealed container and protected in nitrogen atmosphere. This material will be used as a catalyst of the alkylation reactions between isoparaffins and olefins. FIG. 3 shows the catalyst microstructure that was obtained by SEM.

### Example 4

### Alkylation Reaction Using the Sulfonated Polyvinylpyrrolidone Catalyst, PVPHSO₄[Cl]—AlCl₃

In a stainless-steel autoclave equipped with a 68-mL Teflon container, 3 g of PVPHSO4 [CI]-AlCl₃ catalyst are added. The autoclave is locked and purged with nitrogen at pressure of 200 psi, depressurized and again pressurized three times with N₂. The reactor hermeticity is tested, increasing the pressure to 300 psi with nitrogen for 1 h. Once it is verified that the autoclave is hermetically locked, a thermal bath at −6° C. for 30 min is placed; this temperature is the one at which the alkylation reaction will be carried out. The autoclave pressure is stabilized at 120 psi. The mechanical stirring is started at 900 rpm and then 23 g of the reagents isobutane (I) and 2-butene (B) with an I:B ratio of 10:1 are added. The hydrocarbon ratio (isobutane+2-Butene), HC, to the catalyst, CAT, was HC:CAT=7.6:1. The reaction proceeds for 1 h and the stirring is turned off. The reactor is taken from the thermal fluid bath and left to reach 0° C. in order to proceed to recover the gases. A gaseous sample is taken to chromatographic analysis to know the conversion reached by the reaction. When the reactor reaches ambient pressure, it is opened and the liquid obtained from the catalyst is separated. 2 mL of reaction liquid are taken and sent to chromatographic analysis to know the reaction products. Table 1 shows the results that were obtained during the alkylation reaction using the catalyst PVPHSO₄[Cl]—AlCl₃ under the previously described conditions.

TABLE 1
Conditions and results of Example 4.

Reaction Conditions
Catalyst = PVPHSO₄[Cl]—AlCl₃
X = 0.75
Reagents, I + B = 23 g
I/B ratio = 10:1
Temperature = −6
Stirring = 900 rpm
Reaction pressure = 180 PSI
HC:Cat ratio = 7.6:1
Reaction time = 1 h
Conversion (2-butene) = 72.4%

Distribution of compounds in the alkylate

| Compound | Distribution, % |
|---|---|
| C5-C7 | 43 |
| C8 | 28 |
| C9+ | 29 |
| TMPS | 22 |

2,2,4-TMP 8
2,2,3-TMP 1
2,3,4-TMP 3
2,2,5-TMP 10

| | |
|---|---|
| DMHs | 7 |

2,5-DMH 3
2,4-DMH 3
2,3-DMH 1
3,4-DMH 0

| | |
|---|---|
| TMPs/DMHs | 3.1 |

### Example 5

### Preparation of the Sulfonated Polyvinylpyrrolidone Catalyst, PVPHSO₄[Cl]—ZnCl₂

Once the humidity and sulfonation degree of PVPHSO₄ are known, 2 g (0.006 mol) are taken and dissolved in 10 mL of deionized water placed in a 50-mL-2-neck-round-bottom flask, which is kept under magnetic stirring and heated up to 90° C. to add 3.2 g (0.024 mol) of zinc chloride, which has a molar ratio of X=0.80 with respect to PVPHSO₄[Cl] (see Equation 1). The flask is heated in a thermal bath up to 120° C. and 57 mmHg of vacuum are applied, setting the solution under reflux for 2 h. After this time, the vacuum is interrupted with nitrogen and water is evaporated at the same temperature. The Brønsted acidity and the presence of Lewis in this polymer were determined by UV-VIS and IR spectroscopies, which are presented in FIG. 4.

### Example 6

### Alkylation Reaction Using the Sulfonated Polyvinylpyrrolidone Catalyst, PVPHSO₄[Cl]—ZnCl₂

The alkylation reaction of isobutane/2-butene (I/O), obtained from intermediate oil distillates, was carried out in a Robinson Mahoney reactor with a 10:1 (I/O) mixture, keeping it properly pressurized in order to have the reagents constantly as liquefied gases so that the reaction takes place in liquid phase.

1.5 g of PVPHSO₄[Cl]—ZnCl₂ catalyst are placed in the reactor, locking it, and purging it with N₂. The reactor hermeticity was tested by increasing the pressure to 300 psi with nitrogen for 1 h. After this time, the pressure was diminished to 14 psi and heating was started up to 35° C.; once this temperature was reached, 24 g of the isobutane/2-butene mixture were loaded, correcting the pressure by fixing it at 142 psi and starting stirring at 600 rpm; these conditions were constant for 2 h. Once the reaction time was concluded, the stirring was stopped and a gaseous sample was taken to be analyzed by chromatography, cooling down the reactor until reaching −10° C.

For the venting process, the reactor was connected to a bomb and a cold finger, using dry ice; gas flew from the reactor through this system, being liquefied and recovered. Once the venting process concluded, the reactor was opened to separate and quantify the liquid product from the upper part, recovering the catalyst. Table 2 shows the results obtained in the chromatography of the alkylation reaction.

TABLE 2
Conditions and results of Example 5.

Reaction Conditions
Catalyst = PVPHSO₄[Cl]—ZnCl₂
X = 0.80
Reagents I + B = 24 g
I/B ratio = 10:1
Temperature = 35° C.
Stirring = 600 rpm
Reaction pressure = 180 PSI
HC:Cat ratio = 16:1
Reaction time = 3 h
Conversion (2-butene) = 53%
Gasoline selectivity = 10%

### Example 7

### Preparation of the Sulfonated Polyvinylpyrrolidone Catalyst, PVPHSO₄[Cl]—FeCl₃

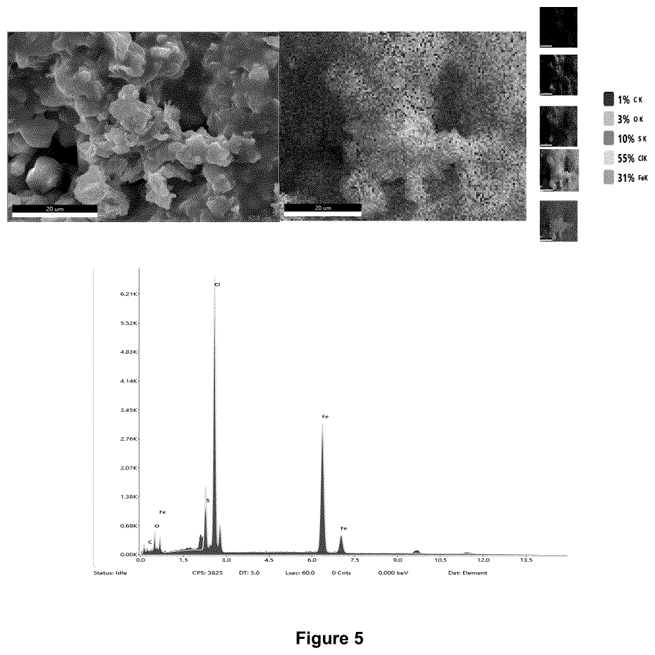

Considering the humidity (%) and sulfonation (%) parameters, the corresponding calculations are done to add 2 g (0.006 mol) of PVPHSO₄[Cl] in a 50-mL-3-neck-round-bottom flask and 15 mL of ethyl acetate; the flask was kept under magnetic stirring and vacuum (55 mm Hg) at 70° C. for 1 h: after this time, the vacuum was interrupted with nitrogen flow to add 6.6 g (0.04 mol) of FeCl₃ at a molar ratio of X=0.67 with respect to PVPHSO₄[Cl]; the mixture was kept under magnetic stirring, increasing the temperature to 90° C. for 3 h. When the reaction finished, the product was maintained at 100° C. with nitrogen flow for 30 min in order to eliminate acetate from the final product. After finishing the drying process, a homogeneous, dark solid was obtained, which was stored in a hermetically sealed amber container and placed in a desiccator to prevent humidity adsorption. By the SEM technique, presented in FIG. 5, the homogeneous incorporation of a metallic salt is observed, in addition to the identification of the peaks corresponding to sulfur, which indicates the presence of —SO₄H groups that were preserved under the reaction conditions; peaks corresponding to iron can also be observed.

### Example 8

### Alkylation Reaction Using the Sulfonated Polyvinylpyrrolidone Catalyst, PVPHSO₄[Cl]—Fe₂Cl₃

In a stainless-steel autoclave equipped with a 58-mL Teflon container, 3 g of PVPHSO₄[Cl]—FeCl₃ catalyst are added. The reactor hermeticity is tested as described in Example 4. In this case, the system is depressurized to 77 psi and kept at 20° C. for 30 min to have a HC/CAT ratio of 8:1.24 g of the I/O mixture (10:1) of real current are fed to start the alkylation reaction, with previous addition of nitrogen to reach pressure of 260 psi. The alkylation reaction lasted 3 h, keeping mechanical stirring at 700 rpm.

Once the reaction was concluded, the reactor was placed in an ice bath to cool it down to 10° C. and recover the gases. The gaseous sample was analyzed by gas chromatography to know the reaction conversion. The reactor was opened and by decantation, the contained liquid along with the catalyst were collected. A liquid aliquot was taken for the chromatographic analysis in order to identify the components of the reaction product. Table 3 shows the results obtained during the alkylation reaction, employing the catalyst PVPHSO₄[Cl]—FeCl₃ under the previously described conditions.

TABLE 3
Conditions and results of Example 8.

Reaction Conditions
Catalyst = PVPHSO₄[Cl]—FeCl₃
X = 0.67
Reagents I + B = 24 g
I/B ratio = 10:1
Temperature = 20° C.
Stirring = 700 rpm
Reaction pressure = 260 Psi
HC:Cat ratio = 8:1
Reaction time = 3 h
Conversion (2-butene) = 88.2%

Distribution of compounds in the alkylate

| Compound | Distribution, % |
|---|---|
| C5-C7 | — |
| C8 | 10 |
| C9+ | — |
| TMPs | 8.4 |
| DMHs | 2.6 |
| TMPs/DMHs | 3.2 |

### Example 9

### Synthesis of Poly (N-vinylpyrrolidone-1-vinyl-3-ethylimidazolium-co-bromide), (VP-EtVim[Br]) (70-30)

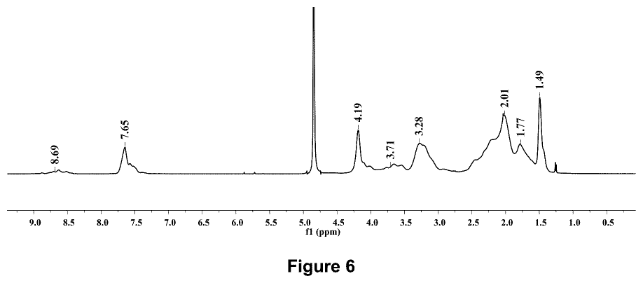

In a 1-L-flat-bottom cylindrical reactor, with a standard 3-neck-flat-flange lid and a neck for a central mechanical stirrer, 28.3 g (0.15 mol) of 1-vinyl-3ethylimidazolium are dissolved in 280 mL of double-distilled and deaerated water. 35.5 g (0.32 mol) of N-vinylpyrrolidone are added. All the reagents are dissolved and homogenized by means of the mechanical stirrer at 50 rpm for 15 min and set under vacuum. Afterward, a porous glass bubbler was connected through one of the necks to the solution core, circulating nitrogen for 20 min. At the same time, along with the nitrogen flow, the oil bath temperature is increased up to 50° C. and is monitored with a thermometer placed in one of the other reactor lid necks. When the reactor reagent solution reaches 50° C., through another reactor lid neck, starts the introduction of a previously deaerated aqueous solution of the initiator V50 in double-distilled water by means of a syringe pump at 1 mL per minute and constant stirring of 250 rpm. Nitrogen flow is kept constant for 10 h of reaction. After this time, a 10-mL sample of the reaction solution is taken to perform several studies. Once the sample is taken and preserving the same temperature and nitrogen flow conditions, 10 mL of the V50 solution are added to the reaction solution at the same concentration employed initially. The temperature, stirring and nitrogen flow are kept for 1 h more. The reaction solution is precipitated with acetone and the precipitate is dried for 8 h under vacuum, and the resulting polymer is ground. The 1H NMR spectrum of the resulting polymer is shown in FIG. 6.

### Example 10

### Synthesis of the Sulfonated (VPHSO₄[Cl]-EtVim [Br]) (70-30) Catalyst

For the sulfonation of the copolymer (VP-EtVim [Br]) (70-30), 6 g (0.038 mol) of copolymer were suspended in 30 mL of dichloromethane, (CH₃)₂Cl, in a 250-mL-2-neck flask. This mixture was kept in suspension with magnetic stirring at 250 rpm, the suspension was cooled down to 0° C. Previously, 3.52 g (0.03 mol) of chlorosulfonic acid were dissolved in 30 mL of dichloromethane, (CH₃)₂Cl; this solution is added slowly to the copolymer suspension. Once the addition was finished, this reaction is left at 0° C. for 2 h; afterward, it is filtered and washed 3 times with (CH₃)₂Cl to be washed 6 times with ethyl acetate. The resulting powder is filtered and dried at 70° C. under vacuum. The final product is hermetically stored in nitrogen atmosphere.

### Example 11

### Synthesis of (VPHSO₄[Cl]-EtVim[Br]) (70-30)-AlCl₃

6 gr (0.026 mol) of dry VPHSO₄[Cl]-EtVim [Br] (70-30) copolymer were placed in a 50-mL-2-neck flask and suspended in ethyl acetate; afterward, the solution was heated up to 90° C. and under N₂ atmosphere, 11.1 g (0.05 mol) of AlCl₃ were added with a molar ratio of X=0.70. Once the addition was finished, the temperature was increased to 120° C. and the mixture was set under vacuum and reflux for 2 h to evaporate the ethyl acetate in nitrogen atmosphere.

### Example 12

### Alkylation Reaction Using the Catalyst (VPHSO₄[Cl]-EtVim [Br]) (70-30)-AlCl₃

Following the procedure in Example 4, in a stainless steel autoclave equipped with a 68-mL Teflon container, 2 g of catalyst (VPHSO₄[Cl]-EtVim [Br]) (70-30)-AlCl₃ are placed and the reaction was carried out in a thermal bath at 0° C. for 2 h, at 290 psi and 700 rpm and I:B ratio of 10:1. The hydrocarbon ratio (HC) (isobutane+2-butene) to catalyst (CAT), HC:CAT, was equal to 10:2. At the end of the reaction, the gases are recovered. A gaseous sample is taken to chromatographic analysis to know the conversion achieved by the reaction. Table 4 shows the results obtained for the alkylation reaction employing the catalyst (VPHSO₄[Cl]-EtVim [Br]) (70-30)-AlCl₃ under the previously described conditions.

TABLE 4
Conditions and results of Example 12.

Reaction Conditions
Catalyst = (VPHSO₄[Cl] —EtVim[Br]) (70-30)-AlCl₃
X = 0.70
Reagents I + B = 20 g
I/B ratio = 10:1
Temperature = 0° C.
Stirring = 700 rpm
Reaction pressure = 290 PSI
HC:Cat ratio = 10:2
Reaction time = 2 h
Conversion (2-butene) = 81%

### Example 13

### Synthesis of (VPHSO₄[Cl]-BVim [Br]) (70-30)-ZnCl₂

Following the synthesis procedure of Examples 9 and 10, the copolymer VPHSO₄ [Cl]-BVim [Br] (70-30) was obtained. It was polymerized in a volume of 300 mL, where 36.52 g (0.32 mol) of VP, 32.5 g (0.14 mol) of BVim [Br], 0.5 g of initiator V50 and 2.2 mL (0.19) of HSO₃CI were added. Once the humidity and sulfonation degree of VPHSO₄ [Cl]-BVim [Br] (70-30) were known, 4 g (0.027 mol) were taken and dissolved in 25 mL of deionized water in a 50-mL-2-neck-round-bottom flask that was kept under magnetic stirring and heated up to 90° C., adding 5.2 g (0.016mol) of zinc chloride, which has a molar ratio of X=0.7 (see Equation 1). The flask was placed in a thermal bath heated up to 120° C., at 57 mm Hg of vacuum with reflux for 2 h. After this time, vacuum was interrupted with nitrogen and water was evaporated.

### Example 14

### Alkylation Reaction Using the Catalyst (VPHSO₄[Cl]-BVim [Br]) (70-30)-ZnCl₂

The alkylation reaction of isobutane/2-butene (I/O), obtained from intermediate oil distillates, was carried out according to Example 6 in a Robinson Mahoney reactor. 3 g of catalyst VPHSO₄[Cl]-BVim [Br]) (70-30)-ZnCl₂ were placed in the reactor, which was hermetically locked and purged with N₂ for 15 min. The reactor hermeticity was verified by increasing the pressure to 300 psi with N2 for 1 h. After this time, the pressure was diminished to 14 psi and the heating process started up to 35° C. Afterward, 24 g of the isobutane/2-butene mixture were loaded, reaching a final reaction pressure of 142 psi; then, stirring at 600 rpm was started, continuing the reaction under the previous conditions for 2 h. Once the reaction time finished, the stirring was stopped and a gaseous sample was taken to be analyzed by gas chromatography and the reactor was cooled down to −10° C.

The venting process was carried out like in Example 5. Table 4 shows the conditions and results obtained with the chromatography of the alkylation reaction.

TABLE 5
Conditions and results of Example 13.

Reaction Conditions
Catalyst = PVPHSO₄[Cl]—ZnCl₂
X = 0.70
Reagents I + B = 25 g
I/B ratio = 10:1
Temperature = 35° C.
Stirring = 1000 rpm
Reaction pressure = 180 PSI
HC:Cat ratio = 8:1; Reaction time = 3 h
Conversion (2-butene) = 86%

### Example 15

### Synthesis of Poly(4VPyPS)

To obtain the desired polymer, the quaternization of 4-vinylpyridine (4VPy) with one alkylsulfonic group is carried out; in this case, propanesultone (PS) is used. This reaction was performed in a round bottom flask, where 0.1 mol of both species in 50 mL of toluene as solvent are added. The reaction proceeds at ambient temperature for 24 h at 300 rpm. The obtained solid material is filtered and washed with ether and then dried under vacuum at 60° C. for 8 h. The resulting monomer was a white solid.

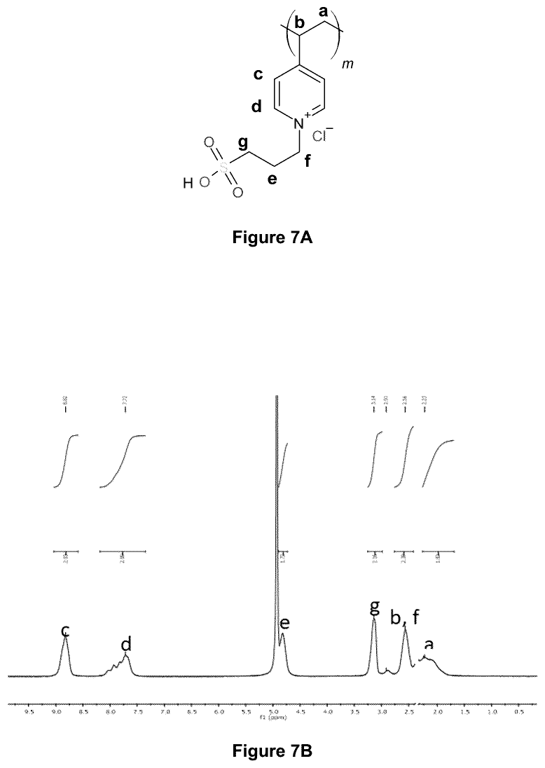

The polymerization process was performed using 0.5 M of NaCl in H₂O, solubilizing the monomer 4VPyPS. The employed initiator is a mixture of 0.1 N dimethylaminopyridine (DMAP) and 0.1 N dimethylformamide (DMF) with ratio equal to 5:1, which is fed at 10 mL/h. The reaction occurs at ambient temperature for 24 h at 300 rpm under aerobic conditions. Afterward, HCl is added with equimolar ratio to the sultone content; this conditioning takes place for 2 h at 90° C. Finally, the obtained compound is precipitated with acetone and washed successively with H₂O and is left to dry under vacuum at 80° C. for 16 h. The structure of the obtained compound is shown in FIG. 7A. Such structure was developed through the analysis of the ¹H NMR spectrum featured in FIG. 7B.

### Example 16

### Synthesis of Poly(4VPyPS)-AlCl₃

The desired catalyst featuring Brønsted and Lewis acid functionalities is obtained by carrying out the synthesis of the polymer given in Example 16 with the integration of the metallic chloride structure.

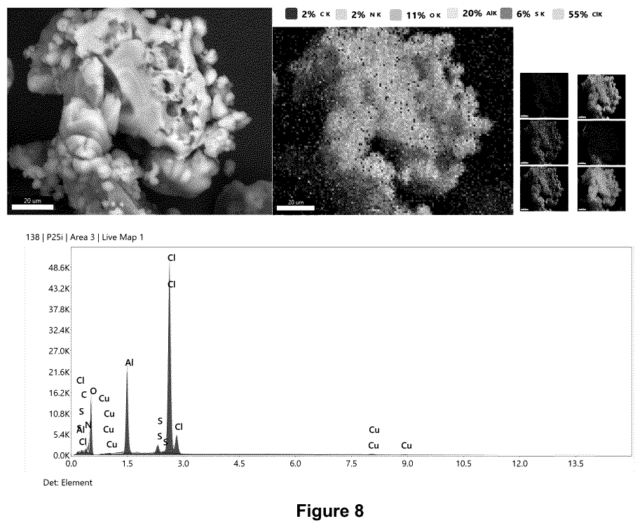

The molar fraction of the metallic salt to be incorporated is 0.7. To determine the corresponding amounts of each reagent, Table 6 is used. The reaction proceeds in a solvent-free atmosphere under vacuum at 80° C. for 2 h. As subproduct of this reaction stage, the formation of HCl vapors is observed. The PIL obtained with two acid functionalities is a granular solid. The elemental analysis of this catalyst using the EDS technique is presented in FIG. 8.

### Example 17

### Alkylation Reaction Using the Catalyst Poly(4VPyPS)-AlCl₃

The reaction was carried out in a batch reactor, where 3 g of catalyst synthesized according to Example 16 were added. The reaction procedure starts with N₂ purge in order to have inert atmosphere. Afterward, N₂ pre-loading is carried out to pressurize the reactor at 116 psi, feeding 23 g of the reagent mixture. The reaction took place at 0° C., 180 psi and 600 rpm for 1 h. When the reaction finished, a sample of gases was taken and a slow venting process was carried out to recover the reaction products. Table 6 shows the conditions and chromatographic results of the alkylation reaction.

TABLE 6
Conditions and results of Example 17.

Reaction Conditions
Catalyst = poly(4VPyPS)—AlCl₃
X = 0.7
Reagents I + B = 23 g
I/B ratio = 10:1
Temperature = 0° C.
Stirring = 600 rpm
Reaction pressure = 180 PSI
HC:Cat ratio = 8:1
Reaction time = 1 h
Conversion (2-butene) = 100%
C8 selectivity = 33.84%

### Example 18

### Alkylation Reaction Using the Catalyst Poly(4VPyPS)-AlCl₃

The reaction was carried out in a batch reactor, where 1.5 g of catalyst synthesized according to Example 16 were added. The reaction procedure started with N₂ purge to have inert atmosphere. Afterward, N₂ pre-loading is done to pressurize the reactor at 116 psi and 23 g of reagent mixture is fed. The reaction occurred at 0° C., 180 psi and 600 rpm for 1 h. Once the reaction finished, a sample of gases was taken and slow venting of the reactor is done to recover the reaction products. Table 7 shows the conditions and results obtained by chromatography of the alkylation reaction.

TABLE 7
Conditions and results of Example 18.

Reaction Conditions
Catalyst = poly(4VPyPS)—AlCl₃
X = 0.7
Reagents I + B = 23 g
I/B ratio = 10:1
Temperature = 0° C.
Stirring = 600 rpm
Reaction pressure = 180 PSI
HC:Cat ratio = 16:1
Reaction time = 1 h
Conversion (2-butene) = 99.8%
C8 selectivity = 62.98%

### Example 19

### Alkylation Reaction Reusing the Catalyst Poly(4VPyPS)-AlCl₃ (Second Reaction Cycle)

The catalyst previously used in Example 18 is separated from the reaction products and used as catalytic load for the present example. The loading procedure and reaction are similar to those in Example 18 in all its stages. Table 8 displays the conditions and results obtained by chromatography of the alkylation reaction.

TABLE 8
Conditions and results of Example 19.

Reaction Conditions
Catalyst = poly(4VPyPS)—AlCl₃
X = 0.7
Reagents I + B = 23 g
I/B ratio = 10:1
Temperature = 0° C.
Stirring = 600 rpm
Reaction pressure = 180 PSI
HC:Cat ratio = 16:1
Reaction time = 1 h
Conversion (2-butene) = 26.46%
C8 selectivity = 62.5%

### Example 20

### Alkylation Reaction Reusing the Catalyst Poly(4VPyPS)-AlCl₃ (Third Reaction Cycle)

The catalyst previously used in Example 19 is separated from the reaction products and used as catalytic load for the present example. The loading procedure and reaction is similar to those in Example 18 in all its stages. Table 9 displays the conditions and results obtained through chromatography of the alkylation reaction.

TABLE 9
Conditions and results of Example 20.

Reaction Conditions
Catalyst = poly(4VPyPS)—AlCl₃
X = 0.7
Reagents I + B = 23 g
I/B ratio = 10:1
Temperature = 0° C.
Stirring = 600 rpm
Reaction pressure = 180 PSI
HC:Cat ratio = 16:1
Reaction time = 1 h
Conversion (2-butene) = 28.32%
C8 selectivity = 62.2%

1. A method for synthesizing poly(ionic liquid) (PIL)-based catalysts for an alkylation reaction of isobutane/butene, said method comprising:
(a) Stage 1: Synthesis of homopolymers from monomers of sulfonated N-vinylpyrrolidone [A] and vinyl ionic liquids (ILs) derived from imidazole with alkyl or alkylcarboxylic chains featuring from 2 to 4 carbon atoms at position 3 of the imidazole ring [B],
wherein: 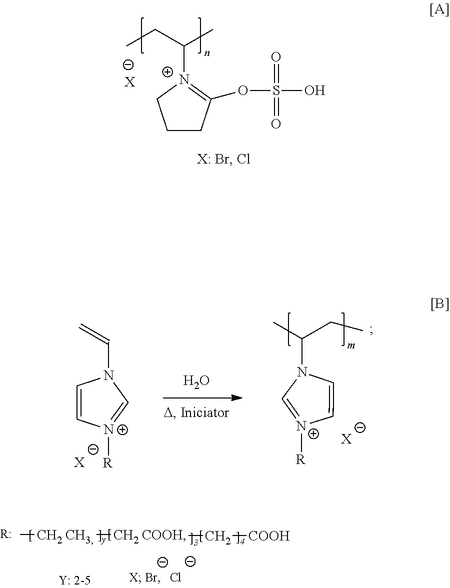
(b) Stage 2: Preparation of copolymers from monomers of N-vinylpyrrolidone and vinyl ILs derived from imidazole featuring alkyl or alkylcarboxylic chains from 2 to 4 carbon atoms at position 3 of the imidazole ring with ratio of the monomers n and m in the copolymer chain from molar ratios of NVP:IL=30:70 to 80:20 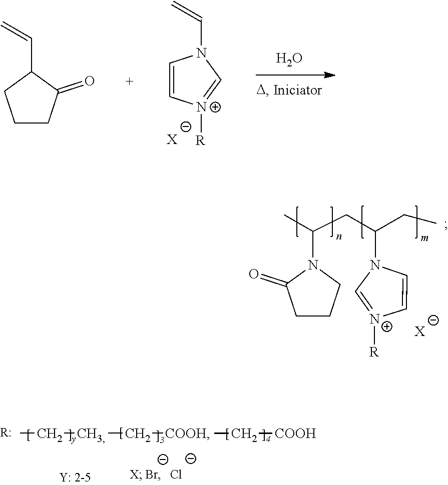
(c) Stage 3: Preparation of copolymers according to Stage 2, wherein positively charged polymers are obtained with halide counterions that comprise Br or Cl in the N-vinylpyrrolidone monomer by treating the copolymers with strong acids selected from the group consisting of chlorosulfonic, 2-bromoetanesulfonic and other haloalkylsulfonic and haloalkylcarboxylic acids or with salts of the corresponding carboxylic acids
wherein 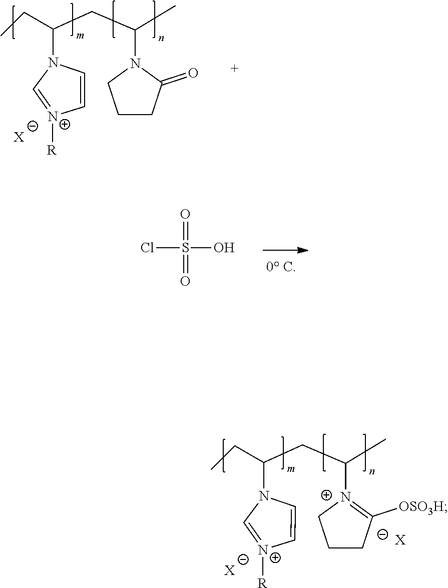
(d) Stage 4: Synthesis of catalysts according to Stages 1, 2 and 3 by incorporating chlorides of metallic salts, wherein the molar fraction of the metallic salt that is added to the polymer or copolymer ranges from X=0.50 to 0.90, and it is calculated by means of equation 1
$$x = \frac{Mol Sal}{Mol Sal + Mol PLI} \qquad ( 1 )$$
wherein Mol Salt corresponds to the moles of the integrated metallic salt and Mol PIL refers to the moles of polymer that will be integrated to produce the catalyst; and
(e) Stage 5: Incorporation of metallic salts into the homopolymers and copolymers from Stages 2,3 and 4 under the same conditions: vacuum, dispersed in ethyl acetate, chloroform, another non-polar solvent and water at temperature ranging from 90 to 150° C.

2. A method for preparing ionic polymers from 4-vinylpyridine functionalized with alkylsulfonic groups (propanesultone or butanesultone) and metallic chlorides such as AlCl₃, but not exclusively, forming Brønsted and Lewis acid sites and that consists of the following stages:
(a) quaternization of 4-vinylpyridine with propanesultone;
(b) polymerization;
(c) addition of Brønsted sites; and
(d) metathesis reaction of metallic halide,
which are displayed in the following schematic representation: 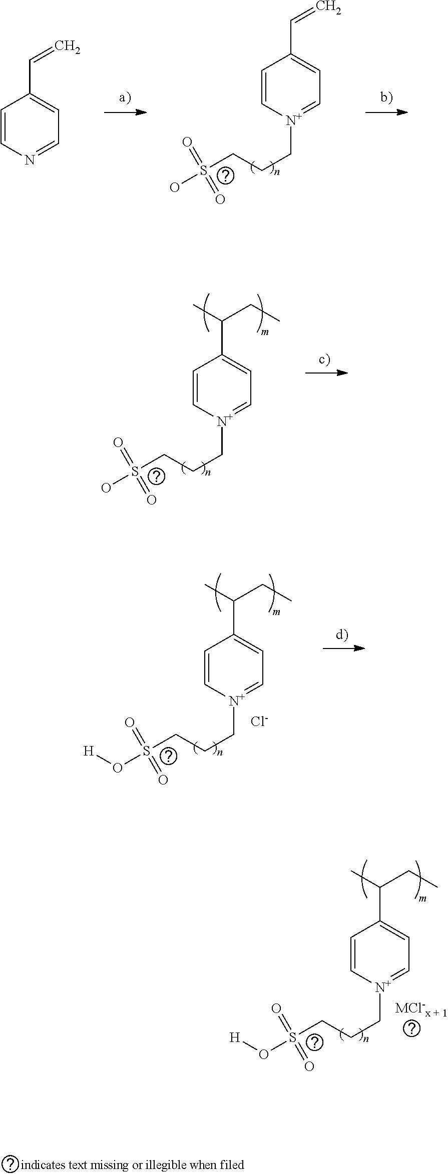
and whose experimental conditions for incorporating the metallic salts into the vinylpyridine-based homopolymers from claim 1 are: under vacuum, solvent-free, within a temperature interval ranging from 50 to 120° C.

3. A method of using the catalytic materials described in claim 1, comprising carrying out the production of alkylate gasoline from the isobutane/butene reaction by employing an autoclave or batch reactor operating at temperatures between −20 and 100° C. and reaction pressure values that can be between 110 and 500 psi in inert atmosphere, with stirring rates between 500 and 1800 rpm, HC:Cat ratio within the (5-20):1 interval and reaction time ranging from 3 to 200 min.

4. A method of using the catalytic materials described in claim 2, comprising carrying out the production of alkylate gasoline from the isobutane/butene reaction by employing an autoclave or batch reactor operating at temperatures between −20 and 100° C. and reaction pressure values that can be between 110 and 500 psi in inert atmosphere, with stirring rates between 500 and 1800 rpm, HC:Cat ratio within the (5-20):1 interval and reaction time ranging from 3 to 200 min.
